(19) United States
(12) Patent Application Publication
(10) Pub. No.: US 2026/0095527 A1
(43) Pub. Date: Apr. 2, 2026

(54) EMERGENCY COMMUNICATIONS CENTER INTELLIGENT WORKFLOW SYSTEM AND METHODS

(71) Applicant: RAPIDSOS, INC., New York, NY (US)

(72) Inventors: Jamison Peevyhouse, Martin, TN (US); David Paul Sehnert, Lafayette, CO (US)

(21) Appl. No.: 18/902,643

(22) Filed: Sep. 30, 2024

(51) Int. Cl. H04M 11/04; G10L 13/02; G10L 15/18; G10L 15/30

(52) U.S. Cl. CPC H04M 11/04; G10L 13/02; G10L 15/18; G10L 15/30

(57) ABSTRACT

A method implements: monitoring, by a cloud server and corresponding cloud application that are operatively coupled to an emergency communication center (ECC), data inputs to the ECC related to incoming emergency calls. The data inputs include voice data. The method further implements: obtaining additional data related to the data inputs, from sources external to the ECC; generating an incident record for each incoming emergency call by correlating the data inputs with the additional data and determining an incident type for each generated incident record; determining units for dispatch to a location of each incident corresponding to an incident record; and providing the determined incident records to an instance of the cloud application, and within a map view user interface, where the instance is executed using a browser on a computer located at the ECC.

### CROSS-REFERENCE TO RELATED APPLICATIONS

None.

### FIELD OF THE DISCLOSURE

The present disclosure relates generally to enhanced 9-1-1 (E911) and next generation 9-1-1 (NG911) emergency networks and more particularly to methods, apparatuses, and systems used in responding to emergencies.

### BACKGROUND

An Emergency Communication Center (ECC) is defined by the National Emergency Number Association (NENA) as “A set of call takers operating under common management which receives emergency calls for service and asynchronous event notifications and processes those calls and events according to a specified operational policy.” A specific type of ECC is a Public Safety Answering Point (PSAP) which NENA defines as an entity responsible for receiving 9-1-1 calls and processing those calls according to a specific operational policy.

ECC call takers utilize various software systems including call handling and call taking software, and computer-aided-dispatch (CAD) systems. Nena defines CAD as “A computer-based system, which aids PSAP Telecommunicators by automating selected dispatching and record keeping activities.” CAD systems are used to respond to a call for service (CFS) (also referred to as an “emergency call”) by creating a corresponding “incident” record, and dispatchers use the CAD system information to dispatch emergency responders to the incident address.

Currently in an ECC, most data points related to Emergency Response, including things like traffic stops, come through an audio format or are supplemented by data. The digital relay of requests for assistance without audio are limited to alarm calls and SMS messaging. For example, calls for service from the community come in via telephone calls to 9-1-1 (or telephone calls to a 10-digit administrative line) into the ECC. An ECC telecommunicator then interacts and interrogates the caller for additional information, gleans what is appropriate for the necessary response type, and then inputs that information into a computer aided dispatch (CAD) system, which is typically designed as a resource management program with a large database integration. The type of information recorded into the CAD database may include caller name, caller phone number, caller address, incident address, a narrative pertaining to the incident, additional historical information about that location and any relevant site hazards associated with that address.

CAD systems also record the status of every unit that is in service during that particular shift. Such units may include law enforcement, fire service, Emergency Medical Services (EMS), etc. The ECC telecommunicator then selects the most appropriate resource/unit for the incident type to be dispatched, and then assigns that unit to that incident. This starts the dispatch process.

In one example of dispatch operations, a 9-1-1 caller reports a stranded vehicle on the side of Main Street partially blocking traffic. The ECC telecommunicator locates the approximate location for that incident, including a cross street and potential local address point that's nearby. That information is determined to be the incident location in the CAD system.

The telecommunicator then assigns the appropriate law enforcement unit responsible for that jurisdiction to respond to that incident, thus being “dispatched”. The telecommunicator then keys the radio to transmit that information in audio format, or sends it digitally via a mobile data terminal (MDT), to the police officer to initiate “response.” The officer, either through the mobile data terminal or over the radio, advises that they are “en route”to that location, or they may reassign to another unit.

As the officer arrives “on scene” to the incident location, there may also be information about the location of the officer based upon AVL (automatic vehicle locating) system location or body camera locations. Additionally, information is gleaned via radio or MDT transmissions concerning the vehicle the officer is approaching. The officer will also provide additional information about the vehicle such as color, year, make/model, body style, additional information, license plate and state (“CYMBALS”).

The officer may also provide additional information about persons in the vehicle, which also gets recorded into CAD by the telecommunicator. As the officer continues the traffic stop, they may provide a disposition, such as the vehicle has been towed by XYZ towing company. When the officer goes back “in service” over the radio (or via the AVL/MDT (mobile device terminal)), the CAD incident is then “closed” and is complete. This incident is removed from the CAD display screen and stored in a database, and the officer is placed back into the pool of resources available for dispatch to another incident.

As can be seen from the above dispatch example, all data points within the ECC originate from audio traffic from the caller or audio traffic from the responder, and data points from the caller (sensors, devices, etc.) or data points from responders (MDTs, AVL, etc.).

In the historical context, CAD is the entry point for all of these data sources by incident or location, entered manually by the telecommunicator. At that point, the owner of the CAD system such as the Dispatch Center or the law enforcement agency, becomes the records custodian for the information relevant to that incident stored in CAD. For a given jurisdiction, only the most severe incidents are reviewed on a daily or weekly basis to ensure quality assurance or for informational purposes for responders.

### BRIEF DESCRIPTION OF THE DRAWINGS

FIG. 1 is a diagram of an Emergency Communication Center (ECC) in communication with a cloud-based intelligent workflow system (IWS) in accordance with an embodiment. The ECC may be a Public Safety Answering Point (PSAP).

FIG. 2 is a diagram of an example intelligent workflow system in accordance with an embodiment.

FIG. 3 is a diagram of an example intelligent workflow system in accordance with an embodiment.

FIG. 4 is a diagram of an example intelligent workflow system in accordance with an embodiment.

FIG. 5 is a flowchart of a method of operation of an intelligent workflow system in accordance with an embodiment.

FIG. 6 is a flowchart of a method of operation of an intelligent workflow system in accordance with an embodiment.

FIG. 7 is a flowchart of a method of operation of an intelligent workflow system in accordance with an embodiment.

FIG. 8 is a flowchart of a method of operation of an intelligent workflow system in accordance with an embodiment.

FIG. 9 is a flowchart of a method of operation of an intelligent workflow system in accordance with an embodiment.

FIG. 10 is a flowchart of a method of operation of an intelligent workflow system in accordance with an embodiment.

FIG. 11 is a flowchart of a method of operation of an artificial intelligence module in accordance with various embodiments.

### DETAILED DESCRIPTION

Briefly, the present disclosure provides an intelligent workflow system (IWS) that utilizes cloud-based capability and that provides, among other things, a workflow system with artificial intelligence features that negate the need for legacy computer-aided-dispatch (CAD) systems, thereby increasing ECC efficiency, decreasing response times, and reducing overall system complexity. One example ECC is a public safety access point (PSAP) that receives and responds to 9-1-1 emergency calls, and dispatches responders such as, but not limited to, police, fire department, and paramedics.

In one aspect, a method implements: monitoring, by a cloud server and corresponding cloud application that are operatively coupled to an emergency communication center (ECC), data inputs to the ECC related to incoming emergency calls. The data inputs include voice data. The method further implements: obtaining additional data related to the data inputs, from sources external to the ECC; generating an incident record for each incoming emergency call by correlating the data inputs with the additional data and determining an incident type for each generated incident record; determining units for dispatch to a location of each incident corresponding to an incident record; and providing the determined incident records to an instance of the cloud application, and within a map view user interface, where the instance is executed using a browser on a computer located at the ECC.

The method may further include performing an auto-dispatch operation of the units. The method may further include: utilizing synthesized speech to perform the auto-dispatch operation of the units. The method may further include generating the synthesized speech using generative artificial intelligence. The method may further include performing natural language processing on the data inputs and the additional data. The method may further include generating an incident record for each incoming emergency call via artificial intelligence. The method may further include: generating an incident record for each incoming emergency call via a generative pre-trained transformer (GPT). The method may further include generating an incident record for each incoming emergency call via a large language model (LLM). The method may further include: determining units for dispatch to a location of each incident corresponding to an incident record, by analyzing AVL (automatic vehicle location) data corresponding to the units, where the data inputs from the ECC include the AVL data. The method may further include: monitoring, by the cloud server and corresponding cloud application, dispatch data inputs to the ECC related to responders present at an incident location, where the dispatch data inputs include radio voice data from the dispatch radio system. The method may further include: updating the incident records based on analysis of the dispatch data inputs and radio voice data. The method may further include: performing natural language processing on the radio voice data.

In another aspect, a cloud based intelligent workflow system includes: at least one cloud server, with a resident cloud application, operatively coupled to at least one ECC functional element, and operatively coupled non-volatile, non-transitory memory. The at least one cloud server is operative to: monitor data inputs to an emergency communication center (ECC) related to incoming emergency calls, including the voice data; obtain additional data related to the ECC data inputs by the cloud server from sources external to the ECC; generate an incident record for each incoming emergency call by correlating the data inputs with the additional data and determining an incident type for each generated incident record; determine units for dispatch to a location of each incident corresponding to an incident record; and provide the determined incident records to an instance of the cloud application, and within a map view user interface, where the instance is executed using a browser on a computer located at the ECC.

The at least one cloud server may be further operative to: perform an auto-dispatch operation of the units. The at least one cloud server may be further operative to: utilize synthesized speech to perform the auto-dispatch operation of the units. The at least one cloud server may be further operative to: generate the synthesized speech using generative artificial intelligence. The at least one cloud server may be further operative to: perform natural language processing on the data inputs and the additional data. The at least one cloud server may be further operative to generate an incident record for each incoming emergency call via artificial intelligence. The at least one cloud server may be further operative to generate an incident record for each incoming emergency call via a generative pre-trained transformer (GPT). The at least one cloud server may be further operative to generate an incident record for each incoming emergency call via a large language model (LLM). The at least one cloud server may be further operative to analyze AVL (automatic vehicle location) data corresponding to the units, where the data inputs include the AVL data. The at least one cloud server may be further operative to monitor dispatch data inputs to the ECC related to responders present at an incident location, where the dispatch data inputs include radio voice data. The at least one cloud server may be further operative to update the incident records based on analysis of the dispatch data inputs comprising radio voice data. The at least one cloud server may be further operative to perform natural language processing on the radio voice data.

In another aspect, a method implements: monitoring, by an artificial intelligence module that is operatively coupled to an emergency communication center (ECC), data inputs to the ECC related to incoming emergency calls, where the data inputs include voice data; obtaining additional data by the artificial intelligence module, from sources external to the ECC, that is related to the data inputs; generating an incident record for each incoming emergency call by correlating the data inputs with the additional data and determining an incident type for each generated incident record; determining units for dispatch to a location of each incident corresponding to an incident record; and providing the determined incident records to an instance of a cloud application that is operatively coupled to the artificial intelligence module, within a map view user interface, where the instance is executed using a browser on a computer located at the ECC.

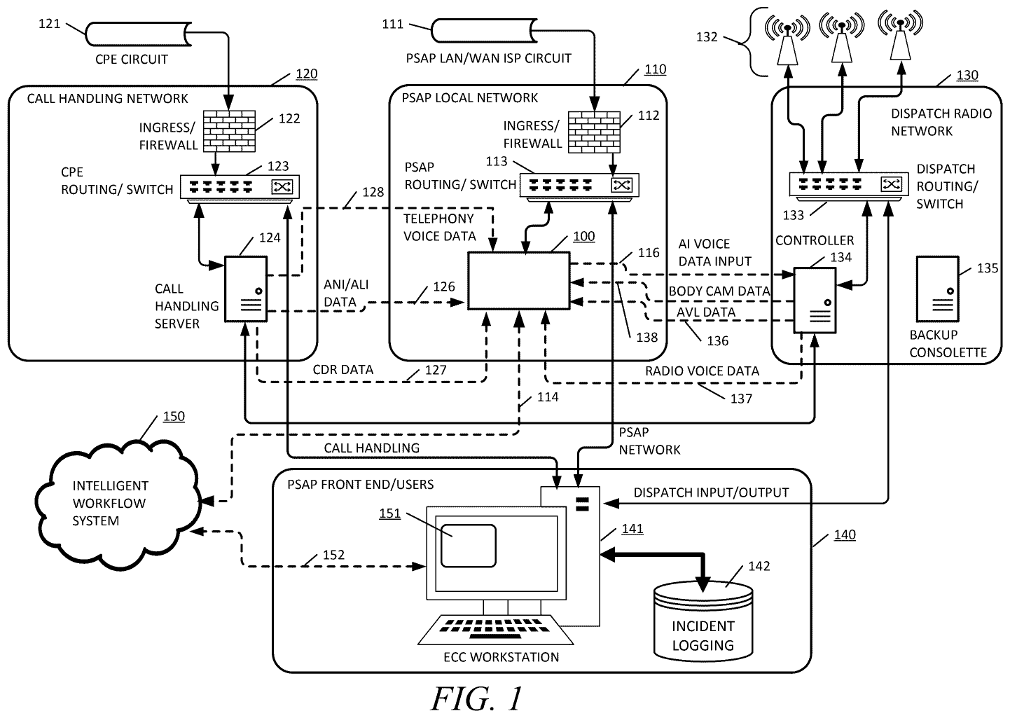

Turning now to the drawings wherein like numerals represent like components, FIG. 1 is a diagram of an Emergency Communication Center (ECC) having an intelligent workflow system 150 in accordance with the embodiments. The intelligent workflow system 150 (IWS 150) is cloud-based and may include an interoperability apparatus 100 installed locally at the ECC. The ECC may be a Public Safety Answering Point (PSAP).

The IWS 150 provides one or more software-as-a-service (SaaS) applications to the ECC in which each application instance is accessed via a portal 151 executing in a browser. The ECC includes Customer Premises Equipment (CPE) which is a set of communications or terminal equipment located in the ECC or PSAP facilities. In telecommunications, the acronym “CPE” may be defined as “customer-premises equipment” or “customer-provided equipment” and refers to any terminal and associated equipment located at a telephone system subscriber's premises and connected with a telephone carrier's telecommunication circuits at a demarcation point. The demarcation point established in a building or complex, or some specific location, separates the specific customer equipment (i.e. the ECC or PSAP equipment) from other equipment located in either the distribution infrastructure or central office of the communications service provider (such as a telephone carrier).

Examples of equipment that may be included in a CPE may include, but are not limited to, active equipment and devices such as telephones, routers, network switches, gateways, networking adapters and Internet access gateways that enable the ECC to access communication services and distribute them within an ECC local area network (LAN); or passive equipment such as analogue telephone adapters (ATA) or xDSL-splitters, including various telephone systems, private branch exchanges (PBXs) etc. Some of this equipment may be devices purchased by the ECC, however some may be provided by one or more service providers that provide telecommunications or other services to the ECC. The ECC CPE may have one or more racks or chassis to encase and hold the CPE equipment and to enable cabling and interconnection via various CPE-peripherals.

Via connections to the call handling network 120, the interoperability apparatus 100 obtains ANI/ALI data 126. The term “ALI” (Automatic Location Identification) is defined by NENA as “the automatic display at the PSAP of the caller's telephone number, the address/location of the telephone and supplementary emergency services information of the location from which a call originates.” The ANI and ALI data collectively may be referred to a “ANI/ALI” data (i.e. “ANI” Automatic Number Identification and “ALI” Automatic Location Identification). The ECC “ANI/ALI system” per the NENA standard, NENA E9-1-1 PSAP Equipment Standards, NENA-STA-027.3-2018 (Jul. 2, 2018), requires that ANI data as received is displayed to the telecommunicator. The ANI/ALI data is displayed by the IWS 150 using a user interface of the portal 151.

The interoperability device 100 also obtains CDR data 127. The ECC “ANI/ALI system” per the NENA standard, NENA E9-1-1 PSAP Equipment Standards, NENA-STA-027.3-2018 (Jul. 2, 2018), is also required to be “equipped with an interface that is capable of providing a CDR (Call Detail Record) output to an optional compatible device,” and desirably “has the ability to store CDR records to a data file that can be downloaded onto recordable media on demand.” The NENA definition of a CDR (Call Detail Record) is “a record stored in a database recording the details of a received or transmitted call.” The NENA standard further requires that a CDR includes: trunk seize time, caller's telephone number, answer time, answering position number, trunk number, trunk release time, time call was transferred, PSAP name or number that the call was transferred to, abandoned call indicator, and date. Although a date does not have to be included in each record, the date must at least be included once per page of records. In addition to the above listed CDR requirements, a CDR may also include: ringing start time, time call was placed on hold, time call was taken off of hold and by what position number, and ALI data. The physical interface for CDR output may be RS-232-C, parallel, network, or USB according to the NENA standard. For these purposes, the ECC workstation 141 may provide CDR data 127 to a local incident logging database 142 if required by ECC operating procedures. However, the information may also be stored in the cloud by the IWS 150.

The interoperability device is also operative to receive AVL data 136. NENA defines AVL data (Automatic Vehicle Location data) as “A means for determining the geographic location of a vehicle and transmitting this information to a point where it can be used.” More particularly, AVL data is information that is used by ECC dispatchers to track the location of vehicles, such as police cars, fire department vehicles, and ambulances, etc., in real-time.

The ECC workstation 141 performs the function of “call handling” which NENA defines as “a functional element concerned with the details of the management of calls.” According to NENA, call handling handles all communication from the caller and includes the interfaces, devices and applications utilized to handle the call. A “functional element” or “functional entity” is defined by NENA as “a set of software features that may be combined with hardware interfaces and operations on those interfaces to accomplish a defined task.” The ECC workstation 141 may be referred to as an APU (Answering Position Unit) which is defined by NENA as “a term used to define call-taking equipment.” However, the ECC workstation, in conjunction with the IWS 150 provides all dispatch features and recording that were previously handled by legacy CAD systems. The ECC workstation 141 is operatively coupled to a CPE circuit 121 via a call handling server 124 and a CPE router/switch 123. The call handling network 120 includes an ingress firewall 122 coupled to the CPE circuit 121 which provides telephone network access to the ECC. The CPE routing/switch 123 is operatively coupled to the ingress/firewall 122.

A PSAP local network 110 also includes a PSAP routing/switch 113 which may be, for example, a network switch or a router connected to a PSAP LAN/WAN ISP (internet service provider) circuit 111 such as, for example, one or more T1 telecommunications lines, or the like, to provide Internet access to the ECC. The ingress/firewall 122, CPE routing/switch 123, ingress/firewall 112, PSAP routing/switch 113, may all be located within one or more equipment racks of ECC/PSAP. Depending on the size of the ECC, multiple APUs (i.e. ECC workstations) such as ECC workstation 141 may be present as the ECC front end 140 to accommodate multiple telecommunicators. The ECC workstation 141 is further operatively coupled to the ECC LAN (PSAP local network 110) and the Internet via the PSAP routing/switch 113, ingress firewall 112 and the PSAP LAN/WAN ISP circuit 111. The ECC workstation 141 accesses the portal 151 via the internet connection 152 provided by the PSAP local network 110.

The ECC further includes components to connect with a dispatch radio network 130 such that the ECC telecommunicators can communicate with responders in the field, such as police officers, fire department personnel, and emergency medical services (EMS). Radio configurations may vary at different ECCs and therefore the dispatch radio network equipment shown in FIG. 1 is for example purposes only. The equipment may include a controller 134 operatively coupled to a dispatch router/switch 133 that enables communications with various base transceiver stations 132 that send and receive radio signals from emergency responder mobile device terminals MDTs 270. The dispatch radio network 130 may be, for example, for a long-term evolution (LTE) wireless network that supports push-to-talk (PTT) over cellular (PoC) functionality or may support instant connect enterprise (ICE) platforms for PTT/PoC and data-rich communications services over public and private LTE. In some installations, a backup consolette 135 may also be present to support communications with the MDTs in the event of network/software outages. The ECC workstation 141 can be used by a telecommunicator to send and receive radio dispatch information using a PoC system implemented by a software console executing on the ECC workstation 141. In accordance with the embodiments, the ECC workstation is operative to send auto-dispatch calls 271 under the direction of the IWS 150. However, the operator has the ability to take over voice communication at any time using controls within the user interface (UI) of the portal 151. The IWS 150 provides the ECC workstation 141 with the portal 151, and the portal 151 provides a user interface incorporating a map view. The map view provides all information necessary for receiving incoming emergency calls and for dispatching first responders to a location for an emergency. Because the IWS 150 provides this integrated system, legacy ECC/PSAP implementations, that utilize separate APUs for call handling and CAD (computer-aided-dispatch) are rendered obsolete. Calls received by the ECC come into the ECC via the CPE circuit 121 and are internally switched or routed to the ECC workstation 141 (APU) as appropriate per the specific ECC call handling operational procedures implemented by the CPE routing/switch 123 and call handling server 124. The IWS 150 actively listens to incoming emergency calls and AI tracks and analyzes the incoming voice data and generates voice-to-text transcription. In some embodiments, the IWS 150 may engage in initial communication with some or all emergency callers to obtain initial data. The operator of the workstation 141 monitors these calls and can take over if necessary or interrupts to engage with the caller. In other embodiments, the operator accepts the calls and communicates with the caller while an AI module of the IWS 150 listens in and extracts all pertinent data such that the ECC operator does not have to perform manual entry of data during the call. The ECC operator however is provided with the capability to modify or edit the data inputs received from the IWS 150.

The term “call” as used herein comports with the NENA definition as “a generic term used to include any type of Request For Emergency Assistance (RFEA); and is not limited to voice.” Therefore, the term “call” may include a session established by signaling with two-way real-time media and involves a human making a request for help.” The terms “voice call”, “video call” or “text call” are used herein when the specific media is of significance. As per NENA definitions, the term “call” may refer to either a “voice call”, “video call”, “text call” or “data-only call”, since they are handled the same way through most of NG9-1-1.” In one example, the ECC may receive short-message-service (SMS), or multi-media service (MMS) messages, and in these cases, the IWS 150 also monitors and provides data to the map view within the portal 151, without the necessity for any operator to manually type in this information.

In the embodiment example shown in FIG. 1, one or more functional elements of the CPE are operatively coupled to an interoperability apparatus 100 installed at the ECC location. The interoperability apparatus 100 includes several connection ports such that the interoperability apparatus 100 is operative to connect to multiple functional elements. In some implementations, a port splitter may be employed, to enable a functional element to connect to multiple devices. In one example implementation of the FIG. 1 configuration, one or more functional element outputs may be connected to a port splitter (not shown) via a serial connection. Each serial connection to the interoperability apparatus 100 may be a DB 9 or DB 25 type connection, a USB connection, firewire connection, or the like, etc. A serial connection may be present between a port splitter and the interoperability apparatus 100 such that the serial connection provides a serial data input to the interoperability apparatus 100 from a CPE functional element. In some embodiments, one functional element may be ANI Controller. In another embodiment one functional element may be an ANI Controller that is integrated into a call handling functional element, such as call handling server 124. In yet another embodiment, one functional element may be an ANI modem bank that is operatively coupled to either a standalone ANI Controller or to an ANI Controller that is integrated into a call handling network 120 functional element. In any of these various implementations, the call handling server 124, the ANI Controller, whether standalone or integrated, and/or the ANI modem bank, may have a limited number of available serial ports. Therefore, a port splitter may be used when needed to accommodate providing one or more additional serial ports. Therefore, in some embodiments serial port splitters may not be required. The interoperability apparatus 100 is operative to receive ANI/ALI data 126, CDR data 127, and telephony voice data 128 from the call handling server 124, or from any functional entities of the call handling network 120 that provide this data, whether via serial or via IP connectivity.

The interoperability apparatus 100 is also operatively coupled to appropriate connection points within the ECC in order to receive AVL data 136, radio voice data 137, and body cam data 138. Depending upon the ECC configuration, the AVL data 136 may be obtained from the call handling network 120, or may be obtained from a connection point at the dispatch radio equipment. The radio voice data 137 may be obtained from, for example, a SPAN port of the controller 134 or from a SPAN port of the CPE if the radio voice data 137 is integrated with the CPE in some ECC configurations. The IWS 150 includes any necessary codecs for digital voice, digital video, etc. to decode and utilize the data.

In some embodiments, the interoperability apparatus 100 is operative to provide AI voice data input 116 to the dispatch radio equipment for purposes of sending auto-dispatch requests. The auto-dispatch requests may include synthesized voice generated using generative AI in the IWS 150 cloud infrastructure. In other embodiments, the portal 151 may interface via APIs with radio dispatch console software executing on the ECC workstation 141 in order to send out synthesized voice dispatch requests via the dispatch radio equipment.

The interoperability apparatus 100 includes serial-to-IP packet conversion capability such that it may convert received serial data to IP (Internet Protocol) packet data, and also include IP ports and is operative to receive IP connections from any ECC functional elements having IP connection capability. The interoperability apparatus 100 is operatively coupled to either the CPE routing/switch 123, or to the call handling server 124, to receive telephony voice data 128 related to emergency calls. In some implementations, the interoperability apparatus 100 may be coupled to one or more SPAN (Switched Port Analyzer) ports of the CPE routing/switch 113, or to the call handling server 124, or the dispatch radio network equipment, in which the SPAN ports mirror the voice data sent to the ECC workstation 141 and also the voice data sent from the ECC workstation 141. The interoperability apparatus 100 is operative to pass the telephony voice data 128 and radio voice data 137 to the IWS 150 for processing. The IWS 150 may perform voice recognition on the telephony voice data 128 and search for key words, or certain combinations of key words, that serve as triggers for other operations of the IWS 150, the interoperability apparatus 100 or both. The IWS 150 may also perform, among other analysis, sentiment analysis on the converted voice-to-text of the conversation, and classification operations, etc.

In one example of such operations, certain detected keywords may trigger an automated dispatch operation of responders by the IWS 150. In one specific example of automated dispatch, keywords such as “heart attack” may trigger dispatch of EMS personnel. Likewise, “burglary,”“robbery,”etc. may trigger dispatch of police officers.

The IWS 150 provides voice-to-text conversion or transcription services and may provide the voice transcripts to other functional entities of the ECC via the interoperability apparatus 100. In one example, the interoperability apparatus 100 may send voice-to-text transcripts, or portions thereof, from the IWS 150 to a local incident recording database 142, if a local database is required by ECC operating procedures. Otherwise, incident recording may be maintained by the IWS 150 within the cloud infrastructure.

The telephony voice data 128 may be voice data from trunked line calls or may be SIP (Session Initiation Protocol) calls using VoIP (voice-over-IP). The SIP state machine information (and also SS7 or C7 data from trunked calls) may also be passed to the interoperability apparatus 100 either as part of the telephony voice data 128, or via a separate data connection from the CPE routing/switch 123 or from the call handling server 124, depending on which provides this data and where a SPAN port may be available. SIP data, SS7 or C7 data may be included in the CDR data 127 received by the interoperability apparatus 100 in some implementations. The SIP state machine data, and SS7 or C7 data, may, among other usages, be used by the IWS 150 to provide logging and data analytics for the ECC, and the IWS 150 may also perform incorporation of the SIP state machine data into CDRs. Likewise, SS7 or C7 data may also be incorporated into CDRs.

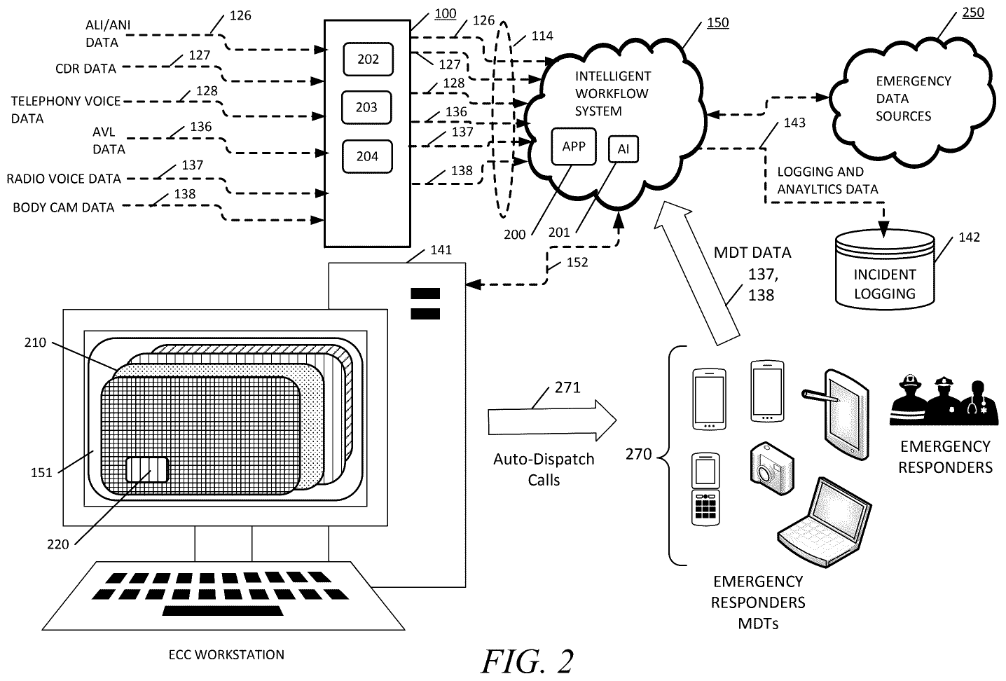

As shown in FIG. 2, In some implementations, the IWS 150 includes the cloud application 200 and an artificial intelligence module 201. The artificial intelligence module 201 (AI module 201) may utilize, or be interfaced with, generative AI such as a large language model (LLM). The LLM may be used to perform various analysis of the telephony voice data 128 and radio voice data 137 including, but not limited to, voice-to-text transcription, keyword and key phrase analysis, context analysis, classification, sentiment analysis, etc. and may also perform or initiate certain operations or actions based on the LLM analysis of the received data. The IWS 150 includes all necessary APIs (application programming interfaces) or DLLs (dynamic link libraries) to receive and manage ECC data passed to it by the interoperability apparatus 100.

The interoperability apparatus 100 includes at least one processor 202, and non-volatile, non-transitory memory 203 that is operatively coupled to the processor 202. The interoperability apparatus 100 includes various connection ports 204, both serial connection ports and IP connection ports, that are operatively connected to the processor. The interoperability apparatus 100 is operative to establish an IP connection 114 with the IWS 150.

The interoperability apparatus 100 is operative to receive ANI/ALI data 126, CDR data 127, telephony voice data 128, AVL data 136, radio voice data 137, and body cam data 138 from the ECC. The interoperability apparatus 100 is operative to send all of this data to the IWS 150 over the IP connection 114. In some embodiments, the non-volatile, non-transitory memory 203 of the interoperability apparatus stores various scripts (i.e. executable code or executable instructions) that when executed by the processor 202, render the processor 202 operative to send and receive the various types of data and communicate with the various types of ECC functional entities. In some implementations, each data type may have a corresponding script such that the interoperability apparatus 100 is easily upgradable or configurable to the specific needs of the ECC at which the interoperability apparatus 100 is installed. In some embodiments, the interoperability apparatus 100 is operative to include an ECC identifier to data it sends to the IWS 150. The ECC identifier is a unique identifier that identifies a specific ECC. The ECC identifier, or components thereof, may be obtained partially or fully from the interoperability apparatus 100, or from any functional entity in the ECC, or may be another unique identifier unique to the ECC.

The IWS 150 provides the cloud application 200 which is accessed via the portal 151 which executes in a browser. The AI module 201 listens to all incoming ECC data and also obtains related data from emergency data sources 250. All of the data is processed by the AI module 201 to provide predictions used to create incidents within the map view of portal 151. Other ECC operations are also implemented in conjunction with the ECC workstation 141. One such ECC operation is auto-dispatch calls 271 in which generative AI utilizes a radio control console (via various APIs) to send synthesized speech. The AI module 201 includes a speech synthesizer for these purposes. In one example, the AI modules detects speech in an incoming emergency call to the ECC. The AI module 201 determines an incident type as a burglary in progress, and obtains all related information such as location, building or homeowner and any other pertinent information. In one further example, the AI module 201 may query national crime databases and present criminal history data such that this information may assist in securing the safety of field responders. Additional units may also be be automatically dispatched based on this data.

This information is presented in the layers 210 of the map view within the portal 151, and an auto-dispatch call 271 is made to the MDTs 270 in order to dispatch police officers to the location. When the police officers arrive at the scene, the AI module 201 listens for any data coming from the MDTs 270. For example, if a police officer recites the CYMBALS information from a vehicle nearby the scene, the AI module 201 records this information without any intervention needed from the ECC workstation 141 operator. The data is then used to update the layers 210 of the portal 151 and is therefore displayed to the operator. Likewise, if the police office types text information into an MDT 270, this data is also captured by the AI module 201.

In some embodiments, the interoperability apparatus may be an AI server with one or more GPUs that are designed specifically to accommodate training and utilization of AI deep learning models such as LLMs and GPTs. The AI server in such embodiments is installed at the ECC and performs the AI operations under supervision of the IWS 150 in the cloud.

In other embodiments, the interoperability apparatus 100 is mostly limited to obtaining and sending ECC data to the IWS 150 cloud infrastructure and a separate AI server is installed at a cloud infrastructure operations center location. In yet other embodiments, the IWS 150 utilizes resources with a cloud-based AI platform and manages the input and output of data with the cloud-based AI platform. In some embodiments, an AI server may be cloud-based and form part of the IWS 150 cloud-infrastructure or may be ancillary cloud-based servers operatively coupled to the IWS 150 cloud infrastructure. The AI module 201 may be implemented using one or more AI servers.

The IWS 150 may utilize a cloud data endpoint which is an API endpoint and may be considered as the end of a communication channel between a functional entity, or the interoperability apparatus 100, and the IWS 150. As mentioned above, a functional entity (or functional element) may be the call handling server 124, an ANI Controller, etc. In that context, a cloud data endpoint may be considered an API (application programming interface) endpoint which enables the IWS 150, via an interoperability apparatus 100, to communicate with the relevant functional entity. For example, a data endpoint, via an ANI/ALI API, may request resources from the interoperability apparatus 100 over the IP connection 114. All data types sent from the interoperability apparatus 100 may utilize the same API endpoint or may have separate API endpoints in some embodiments.

In some embodiments, an API at a data endpoint may be a RESTful API in which each ECC interoperability apparatus 100, from any of various ECCs, may represent an endpoint from which the cloud data endpoint can obtain any ECC data of the various ECC data types (i.e. ANI/ALI data 126, CDR data 127, telephony voice data 128, AVL data 136, radio voice data 137, body cam data 138, and the like, etc.) The endpoint API may define at least one URL endpoint with a domain, port, path, query string, or combination of these, etc., and within these definitions will be a unique ECC identifier.

The IWS 150 is cloud-based, and may include one or more virtual servers, distributed servers, hardware servers, etc., and distributed non-volatile, non-transitory memory storage as required to provide a SaaS (software-as-a-service) capability to the various ECCs such as the cloud application 200. Each portal 151 executed on an ECC workstation corresponds to an instance of the cloud application 200 provided by the IWS 150.

The IWS 150 provides data layers 210, and may also provide logging and analytics data 143 in accordance with an embodiment. The logging and analytics data 143 may be provided to an incident logging database 142 that is stored locally at the ECC, or may utilize cloud database storage. A logging and analytics workstation may be provided with a logging and analytics interface provided via the portal 151. Among other features, the portal 151 provides a map view with location indicators corresponding to emergency calls directed to the ECC (whether call routing is completed through the telephony network or not) and a call queue with ANI (caller ID) data for each call, in addition to other data such as ADR (additional data repository) data, medical data, etc. from the emergency data sources 250. The map view also includes all ECC emergency data obtained by the interoperability apparatus 100 and each ECC data type may be displayed in the portal 151 by activating the specific layer of data layers 210. Some ECC data may also be displayed in a popup window 220 and all of the display options are configurable by the ECC workstation 141 user.

The IWS 150 is operative to receive mobile device location data, and other emergency data, from various mobile location servers within emergency data sources 250. The IWS 150 is also operative to receive emergency alerts from various emergency alert systems such as those described in U.S. Pat. No. 11,749,094 issued Sep. 5, 2023 to Pellegrini et al. Such emergency alerts may include, but are not limited to, home security alarms (which may include burglar alarms, fire alarms or other types of alarms), alarms for commercial buildings and institutions (which may also include burglar alarms, fire alarms, hazard alarms, etc.), medical bracelets, medical devices, etc. The mobile location servers receive hybrid location data from mobile devices via Internet connectivity to the mobile devices, and the data may include for example, but are not limited to, Android Mobile Location (AML) data, Android Emergency Location Service (ELS) data, and Hybridized Emergency Location (HELO) data provided by iOS™ devices, and other mobile device location data, etc. In some embodiments, the IWS 150 uses the data from a cloud-based data endpoint to identify emergency location data and other data associated with device identifiers (i.e. ANI/ALI data) and can match up data from the cloud-based data endpoint with other available emergency data to provide more complete and accurate information to the ECCs. The match up of cloud-based data endpoint data with data received by the IWS 150 enables identification of emergency calls that have been routed to the ECC via telephony routing. However, the IWS 150 information is not limited to emergency calls that have been routed to the ECC via telephony routing and the data obtained from the mobile location servers, additional data servers, and emergency alerts systems can be obtained by the IWS 150 and provided to the portal 151 prior to the ECC receiving and answering the call. The AI module 201 may, depending upon the data types received, by able to predict the incident type for the incoming data and create the appropriate on-screen alert within the portal 151. The portal 151 may also provide an emergency call queue (in addition to the map view). The map view location indicators for devices from which emergency calls have emanated even before completion of the emergency call routing to the ECC by the telephony network.

Because either a cloud-based identification and authentication function, or the interoperability apparatus 100, adds an ECC identifier to data it receives, likewise the IWS 150 identifies data relevant to each particular ECC and uses the ECC identifier to push related data for the specific ECC, and to an appropriate ECC workstation. The IWS 150 determines which ECC should receive what data based on related mobile device location and whether a specific device that placed a call is located within an ECC geofence specified in a geofence database. As the IWS 150 detects calls arriving at an ECC via data it receives from the interoperability apparatus 100, or via the data it receives via the emergency data sources 250, the IWS 150 actively updates the layers 210 with the portal 151 map view. The operator may toggle specific layers of layers 210 on and off depending upon the operator's preferences or specific needs during handling a call or dispatch operation. However, the AI module 201 may automatically activate certain layers that are relevant to certain incident types to provide the operators with appropriate data updates.

The data updates may be displayed the AI module 201 within a popup window 220 that displays as new data arrives, or when the ECC workstation 141 operator hovers the mouse cursor over a location indicator or other indicator associated with an emergency call displayed on the map view. Some layered data may appear as a pop-up when a mouse cursor is hovered over a particular location indicator, when that specific data layer is toggled on. Some or all of the available data may be displayed within the call queue.

The interoperability apparatus 100 may send data to the IWS 150 in a streaming manner, or as a data push operation, as the data is obtained by the interoperability apparatus 100. In response to receiving data from the interoperability apparatus 100 whether sent in a data stream, as a push operation, or as a data query made via the portal 151 by an ECC workstation 141 operator, the IWS 150 provides, or returns in response to a query, emergency data which includes, but is not limited to, augmented device location information and other additional data processed by the AI module 201.

For handling data, the interoperability apparatus 100 may use RESTful API HTTP methods such as GET, POST, PUT, and DELETE. However, the interoperability apparatus 100 may use the POST method to send data to the IWS 150 to create or update a resource at a cloud-based data endpoint. When the interoperability apparatus 100 sends a POST request to the cloud-based data endpoint, it will normally be accompanied by a payload of data that is used to create or update the resource on the data endpoint. In some embodiments, the data may be in the form of a JSON object. In some embodiment, the JSON object may be an EIDO (“Emergency Incident Data Object”). In some embodiments, the data may be in XML format. The interoperability apparatus 100 may also use the PUT method to update an existing resource on the data endpoint. For example, the data endpoint may send ANI/ALI updates via PUT when a mobile device in an emergency call changes locations, or for AVL data when an emergency responder vehicle changes location, etc. The IWS 150 uses any of the RESTful API HTTP methods such as GET, POST, PUT, and DELETE to handle data with the interoperability apparatus 100, and also to provide data to the portal 151.

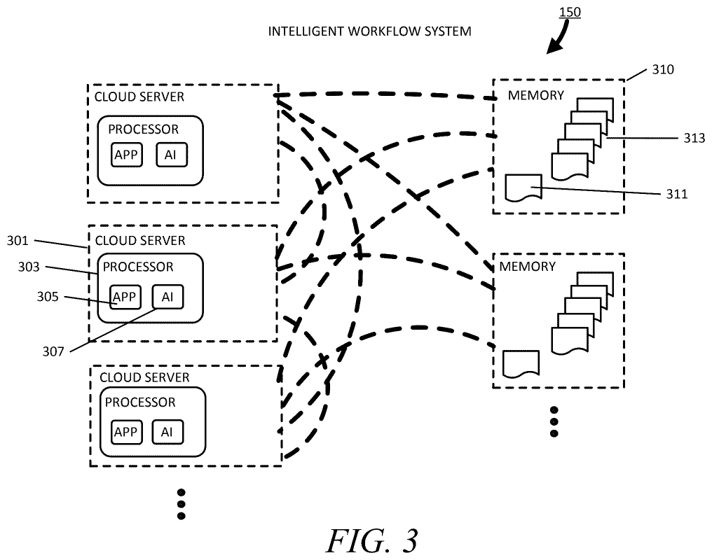

FIG. 3 is a diagram showing further details of the IWS 150 in accordance with various embodiments. The IWS 150 includes a number of cloud servers 301, with each cloud server including at least one processor 303 operative to execute the cloud application 305. The IWS 150 also includes a number of non-volatile, non-transitory memory 310 that store executable instructions (code) 311 for the cloud application 305. The memory 310 may also store numerous scripts 313, which are also executable instructions, for data operations including, but not limited to, data format conversions for the various types of data received by the IWS 150. This data received by the IWS 150 includes, but is not limited to, ANI/ALI data, CDR data, telephony voice data, radio voice data, AVL data, body or vehicle cam data, mobile device hybrid locations data, additional data repository (ADR) data, alarm data, and the like, etc. The scripts 313 may include scripts that are tailored for specific ECCs in order to meet the specific ECCs detailed requirements for data handling and data presentation, etc. The ECC detailed requirements include, but are not limited to, the specific types of data handled for that ECC and the specific data fields included in those data types for that ECC. The scripts 313 may be executed by the IWS 150 on the cloud servers 301 as needed when specific types of data are received and for specific ECCs, etc. The interoperability device 100 located at each ECC is operative to receive data processed by the scripts 313 and may also send the data, if needed, to specific functional elements within the ECC. The IWS 150 is operative to send data to the cloud-application 305 instance at each ECC accordingly as needed to update the IWS portal 151 for each cloud-application 305 instance executing at each ECC. The IWS 150 also includes AI modules 307 that may utilize generative AI such as LLMs and may implement those LLMs using GPTs etc. The LLMs may be specifically trained LLMs for ECC data management in some embodiments.

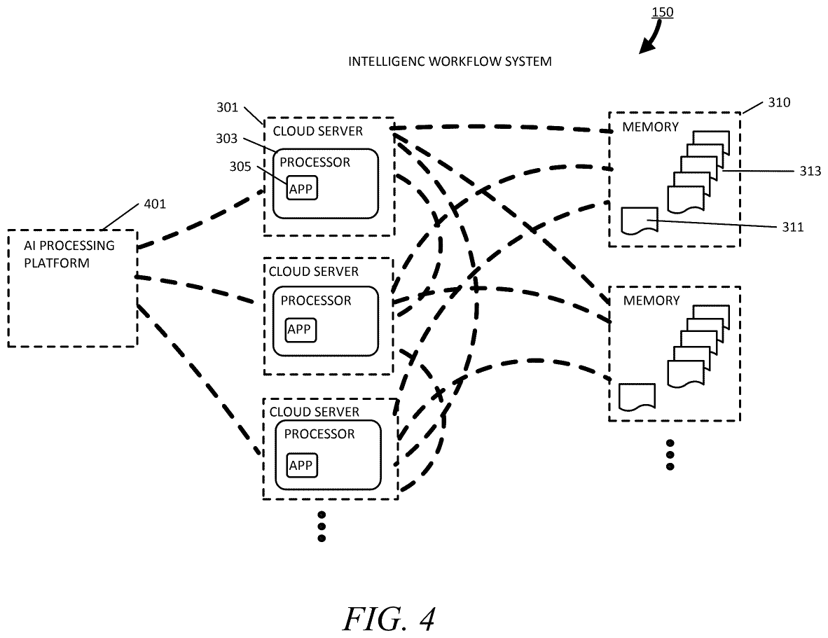

FIG. 4 illustrates a configuration of the IWS 150 in accordance with another embodiment. In FIG. 4 the cloud servers 301 access resources on a cloud-based AI processing platform 401 where generative AI capability such as LLMs as well as other machine learning capabilities are resident. In this configuration, the IWS 150 cloud servers 301 pass ECC information to the AI processing platform 401 and receive back the generative AI outputs (such as LLM outputs), or machine learning outputs for some data types or both generative AI outputs and machine learning outputs.

In operation of the IWS 150, artificial intelligence is introduced into the ECC workflow and includes the AI listening to emergency callers, listening to the radio traffic, listening to the telecommunicators input, and storing that information based upon a location of the incident provided by one of those three avenues. Among other advantages, the need for an on-premise, legacy database system, such as CAD, is negated.

The IWS 150 includes all needed APIs for ingression of standards-based input of audio and textual data and digital, but provides the ECC workstation operator 150 with the ability to barge in to voice calls requiring human intervention. Calls requiring transfer can be initiated by the ECC workstation 141 operator or by the AI module and delivered via cloud-based VoIP connectivity. Calls for service may be automatically shared with neighboring agencies to share status, request assistance, or request resources utilizing standards-based data schema for interoperating with legacy systems. In addition, the IWS 150 is operative to operate as a data/resource sharing platform and can share data beyond traditional field responders to include emergency management, government leaders and media with the data being filtered to the information needed by each of these parties.

Every workflow or function of legacy CAD implementations is replaced by artificial intelligence via audio transcription and other features of the IWS 150. Because the AI module gathers and coordinates all data related to emergency calls and dispatch operations and communications, the ECC operator does not need a traditional tabular UI/UX interface to input information for incidents. The IWS 150 AI resolves the location of the incident, type of incident, narrative information, etc. and provides that information directly onto the map view of the portal 151.

By monitoring all audio on the radio interface, the IWS 150 AI can effectively maintain unit statuses from the time they go in service to the time they check out of service for their shift, for any given jurisdiction. The mapping interface on the portal 151 lists the status of each unit available or assigned to an incident based upon their location, based upon their radio traffic, and/or based upon user input into the mapping interface.

In some embodiments, the AI module automatically recommends the closest available unit based upon the incident type, incident location, responder availability, and/or the type of resources that responder has available. The IWS 150 can provide vehicle routing instructions based on the type of vehicle, real-time traffic status, routing rules (e.g., send units from north and south on an interstate accident), and special event parameters (e.g., high-profile event, such as a presidential inauguration).

Therefore, the typical GUI interface for a CAD implementation is completely replaced by the graphical mapping interface of the portal 151, mostly controlled by artificial intelligence, with direct and overriding input from the ECC workstation 141 operator as needed.

As a local ECC entity is also the records custodian for all incidents of its respective jurisdiction, the ease of surfacing incidents based upon location, time of day, nature of incident, day of the week, responder's name, caller's name, telecommunicator's name, etc., can be surfaced using the AI module as a query tool. In some embodiments, the IWS 150 may provide results as a paper output (or file output) in a tabular format as is most commonly used with legacy CAD implementations. However, the IWS 150 may also provide an animated gif or video that shows how the actual incident unfolded in real time.

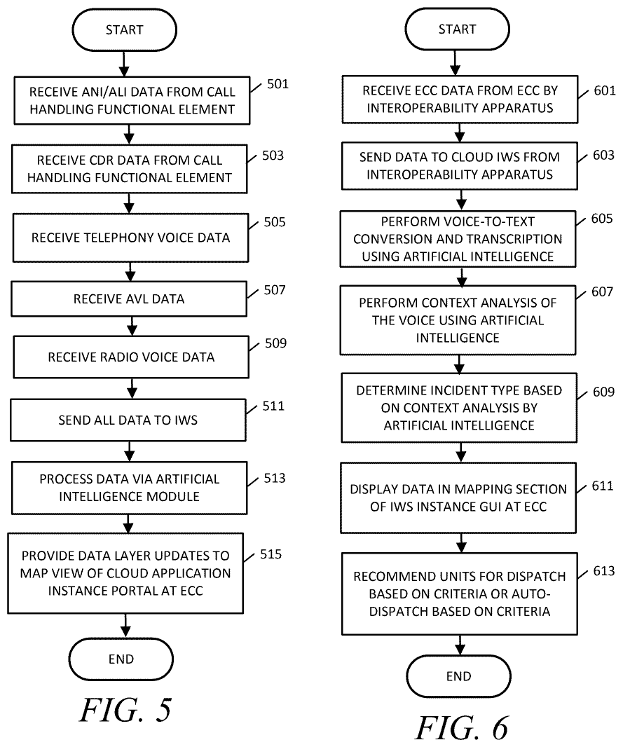

FIG. 5 is a is a flowchart of a method of operation of an IWS 150 in accordance with an embodiment. At operation 501 the IWS 150 receives ANI/ALI data from a functional element of the call handling network 120. The functional element may be an ANI/ALI modem, the CPE routing/switch 123, the call handling server 124, or the like, etc. At operation 503 the IWS 150 receives CDR data from a functional element of the call handling network 120. At operation 505 the IWS 150 receives telephony voice data from a functional element of the call handling network 120. At operation 507 the IWS 150 receives AVL data from a functional element of the ECC which may be within the call handling network 120 or the radio network equipment. At operation 509 the IWS 150 receives radio voice data from the dispatch radio equipment. At operation 511 the interoperability device 100 sends all received data to the IWS 150 cloud processing. The data may be sent to the IWS 150 cloud processing by the interoperability apparatus 100 as it is received, in a packetized format, a streaming format, using a PUSH operation or the like, etc. At operation 513 the data is processed by the IWS artificial intelligence module. At operation 515, the IWS 150 incorporates the processed data into data layers 210 for that ECC within the cloud application, and provides the data layers 210 to the cloud application instance at the ECC via the portal 151.

FIG. 6 is a is a flowchart of a method of operation of an IWS 150 in accordance with an embodiment. At operation 601 the interoperability apparatus 100 receives ECC data from various ECC functional elements within the call handling network 120, radio dispatch network 130, PSAP local network 110, etc. At operation 603 the interoperability apparatus 100 send the ECC data to the IWS 150 over an internet connection. At operation 605 the IWS 150 artificial intelligence performs voice-to-text conversion and transcription. At operation 607 the IWS 150 artificial intelligence performs context analysis of the voice data, and at operation 609 determines an incident type based on the context analysis. The incident types may be, for example, police incidents, fire related incidents, medical incidents, etc. with various subcategories. At operation 611 the IWS 50 displays the AI processed data in the portal 151. At operation 613, the IWS 150 AI recommends units for dispatch to the incident location, or otherwise performs auto-dispatch based on criteria. The criteria may be, for example, unit location and availability, resources available to the unit, and the like, etc.

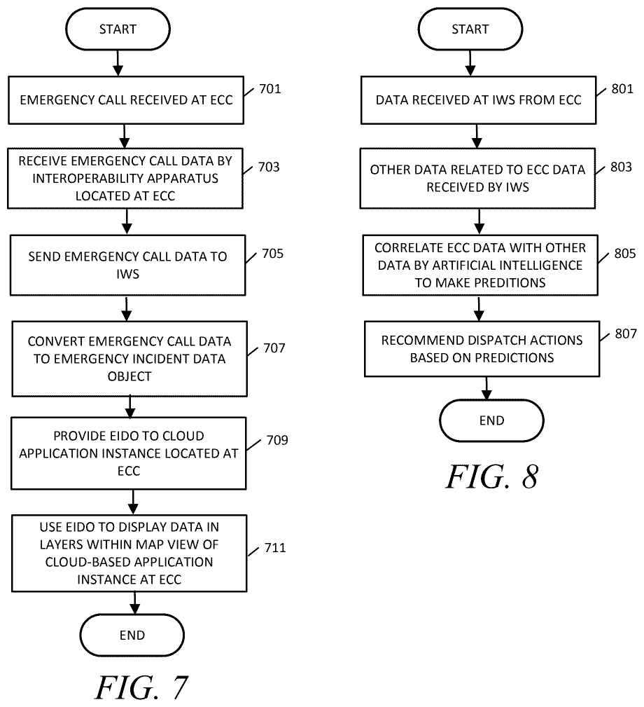

FIG. 7 is a is a flowchart of a method of operation of an IWS 150 in accordance with an embodiment. At operation 701 an emergency call is received at the ECC which means it has begun to be processed within the call handling network 120. At operation 703 the interoperability apparatus 100 receives related emergency call data from the various functional elements. At operation 705 the interoperability apparatus 100 sends the emergency call data to the IWS 150 cloud processing. At operation 707 the IWS 150 converts AI processed emergency call data into an EIDO format and at operation 709, provides the EIDO to the cloud application instance map view at the ECC. At operation 711 the EIDO is used to display the AI processed data within a map view, or other sections, of the cloud application instance via the portal 151.

FIG. 8 is a flowchart of a method of operation of an IWS 150 in accordance with an embodiment. At operation 801 ECC data is received by the IWS 150. At operation 803 the IWS 150 received other data from emergency data sources 250 related to the ECC data. For example, the IWS 150 receive hybrid location data from mobile devices that have placed emergency calls. The IWS 150 may also receive ADR data related to the mobile phone number and user. In a police incident situation, the IWS 150 may obtain perpetrator information from national crime database, and the like, etc. At operation 805 the IWS 150 AI correlates the received ECC data with the other data obtained from emergency data sources 250 and makes predictions. The predictions may include, but are not limited to, type of incident, equipment and resources required to respond, criticality or severity of the incident, and the like, etc. At operation 807 the AI makes recommendations for dispatch based on the predictions.

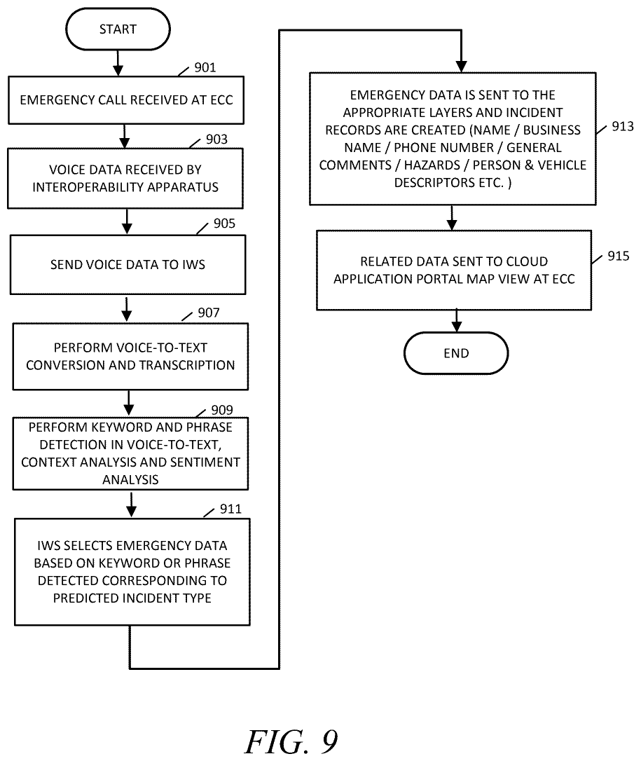

FIG. 9 is a flowchart of a method of operation of an IWS 150 in accordance with an embodiment. At operation 901 an emergency call is received at the ECC which means it has begun to be processed within the call handling network 120. At operation 903 telephony voice data 128 is received by the interoperability apparatus 100 from a functional element of the call handling network 120. At operation 905 the interoperability apparatus 100 sends the telephony voice data 128 to the IWS 150 for processing by the AI. The telephony voice data 128 may be sent as digital voice data contained in data packets. In some embodiments, the telephony voice data 128 may be send as streaming audio. At operation 907 the IWS 150 performs voice-to-text conversion and transcription. In some embodiments, voice-to-text conversion may be performed by the interoperability apparatus 100. At operation 909 the IWS 150 performs keyword and phrase detection in the voice-to-text data and also context and sentiment analysis. The IWS 150 may also analyze the audio frequency and tone to perform emotional stress analysis. At operation 911 the IWS 150 selects emergency data based on the analysis and corresponding to a predicted incident type. The incident type may be predicted by the IWS 150 based on the detected keywords and phrases, context and sentiment, and other analysis, etc. At operation 913 the selected emergency data is sent to the appropriate data layers 210 of the cloud application and incident records are generated by the AI using generative AI capabilities (i.e. summaries, gif files of real time incident play out where video is available, etc.) At operation 915 the related data is also sent and displayed within the ECC portal 151 in the map view.

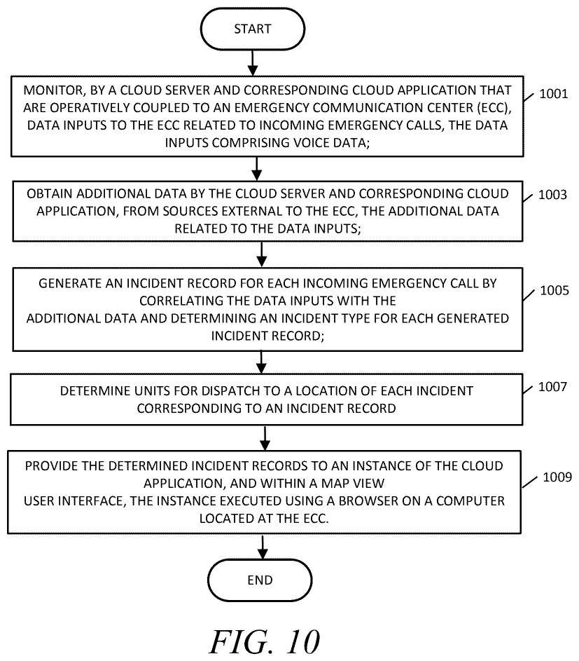

FIG. 10 is a flowchart of a method of operation of an IWS 150 in accordance with various embodiments. At operation 1001, the IWS 150 monitors data inputs to the ECC related to incoming emergency calls. The data inputs include ANI/ALI data, call handling data, CDR data, telephony voice data, and the like, etc. At operation 1003, the IWS 150 obtains additional data from emergency data sources 250 which are sources external to the ECC. The additional data includes, but is not limited to, mobile device hybrid location data, ADR (additional data repository) data such as medical data, national crime database data, state or national vehicle registration data, state or national firearms registration data, hazardous material information, utility infrastructure data, and the like, etc. At operation 1005, the IWS 150 generates an incident record for each incoming emergency call by correlating the data inputs with the additional data and determining an incident type for each generated incident record. At operation 1007, the IWS 150 determines appropriate units to dispatch to each incident location corresponding to an incident record and based on AI analysis and predictions. In some embodiments, the IWS 150 also performs an auto-dispatch operation of units to the incident location. The units may be, for example, police cars, ambulances, fire trucks, hazmat teams, etc. as required for the incident type determined by the AI module 201.

The IWS 150 may utilize synthesized speech to perform the auto-dispatch operation of the units, and the synthesized speech may be generated using generative artificial intelligence in the AI module 201. The AI module 201 may, among other things, perform natural language processing on the data inputs and the additional data. The IWS 150 is operative to interface with the dispatch radio network 130 equipment at the ECC to send and receive dispatch messages. The dispatch messages may be sent as broadcast messages to all available units or may be directed to specific units. At operation 1009, the IWS 150 updates the portal 151 with analyzed data, and recommendations.

The AI module 201 is operative to generate an incident record for each incoming emergency call via artificial intelligence. The AI used to generate incident records may be, for example, but is not limited to, a large language model (LLM). The AI, in some embodiments, may further be a generative pre-trained transformer (GPT).

During dispatch, the AI module 201 is operative to listen to communication from and to the ECC from the various responders (via the MDTs 270). The AI module 201 is also operative to analyzing AVL data that the IWS 150 obtains corresponding to the units and may access availability, current location and time to arrive at an incident location, resources and capabilities of the various units and responders, and the like, etc., in order to determine the most appropriate units to dispatch to a given incident location. Using this analysis, at operation 1007, the IWS 150 determines units for dispatch to a location of each incident corresponding to an incident record, and at operation 1009, the IWS 150 provides the determined incident records to an instance of the cloud application, and within the map view user interface of portal 151 executed using a browser on the ECC workstation 141.

Subsequent, or during, dispatch operations the AI module 201 monitors dispatch data inputs to the ECC related to the responders present at an incident location, including the radio voice communications. As this occurs, the AI module 201 updates the incident records based on analysis of the dispatch data inputs and the portal 151 map view layers 210 are updated in substantially real time. The AI module 201 performs the same types of analysis on the radio voice data as it does for the telephony voice data incoming to the ECC. Additional “dispatch data” may include body cam data (which may consist of video images, audio, timestamps, location, etc.), vehicle data (which may consist of the AVL data, as well as video images, audio, timestamps, location, etc. from onboard cameras, and other data).

As with the telephony voice data, the AI module performs natural language processing on the radio voice data. Analysis performed may include, but is not limited to, sentiment analysis, frequency/tone analysis to determine the emotional stress level of callers, responders, bystanders/witnesses, etc. Image recognition and facial recognition may also be employed and used by the AI module 201 to conduct database queries of the emergency data sources 250 (such as, but not limited to, national crime databases, vehicle registration databases, and the like, etc.) Image recognition may be used by the AI module 201 for example, to detect weapons or other dangerous objects at the location of an incident based on body cam video, vehicular cam video, or other externally available video sources such and Internet-of-Things (IoT) camera devices and sensors which may be accessible to the AI module 201. In another example, the AI module 201 may access gunshot detection equipment to obtain audio or determinations (such as detection of a gunshot and its approximate location) made by such equipment.

The IWS 150 performs analysis and detects patterns in the data, using the AI module, which would not be perceptible to human users, or otherwise could not possibly be assessed by human users within any reasonable period of time so as to facilitate an appropriately timed, and resourced, response to an emergency incident. Additionally, the IWS 150 handles multiple incoming emergency calls and dispatch operations in a substantially simultaneous manner which could not be humanly accomplished because a human operator is limited to a single interaction at a time, even if performing so-called, “multi-tasking.” The IWS 150 therefore provides and performs practical applications that are not possible to perform by human activity. The IWS 150 increases the efficiency of an ECC and reduces the overall response time to emergency incidents by making assessments and decisions.

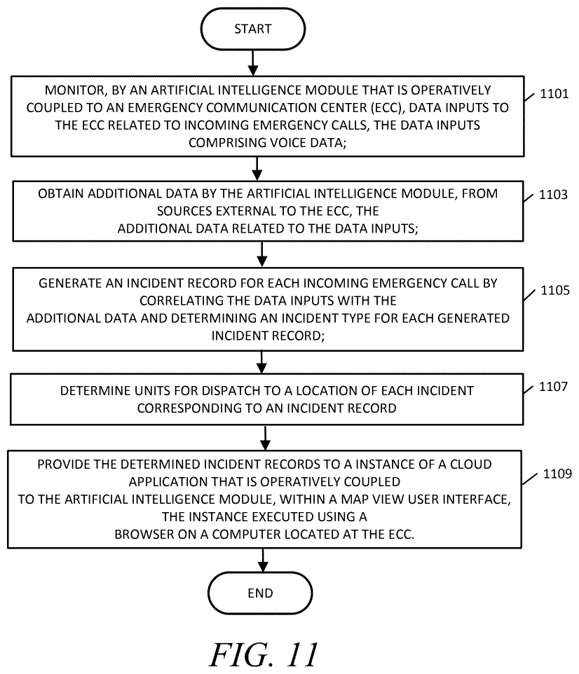

FIG. 11 is a flowchart of a method of operation of an artificial intelligence module in accordance with an embodiment. At operation 1101, the AI module 201 that is operatively coupled to the ECC, monitors data inputs to the ECC including voice data related to incoming emergency calls. At operation 1103, the AI module 201 obtains additional data from sources external to the ECC, where the additional data is related to the data inputs. At operation 1205, the AI module 201 generates an incident record for each incoming emergency call by, among other analysis, correlating the data inputs with the additional data and determining an incident type for each generated incident record. At operation 1107, the AI module 201 determines units for dispatch to a location of each incident corresponding to an incident record, and at operation 1109, provides the determined incident records to an instance of the cloud application 200 that is operatively coupled to the AI module 201, and the updates are displayed within the map view user interface of the portal 151.

The AI module 201 may include an LLM which may further be a GPT. However, the AI module 201 may include more than one AI models and may include various machine learning models. The AI module 201 is operative to employ various machine learning techniques such as, but not limited to, regression, decision trees, random forests, etc. and may employ an LLM to perform some, or all of these techniques as appropriate for the received data inputs and external sourced data. Therefore, in accordance with the embodiments, various machine learning models as well as generative AI may be used in combination to achieve the results of the embodiments herein described. The AI module 201 corresponding various AI models are trained using ECC data from one or more ECCs collected over a period of time from weeks, months or years. In one example, a regression model may be built using a neural network that may be trained to make predictions of emergency incident types using the ECC data inputs and externally sourced data which may include, but is not limited to, sensor data, video data, image data, facial recognition data, frequency/tone emotional state assessment data, text data, audio data, or using any combination thereof. Any utilized machine learning models may also be updated from time-to-time using new or additional training data, or may be updated using reinforcement learning from human feedback (RLHF) in order to optimize the machine learning models.

For utilization of LLMs, prompts are engineered and tested using the same ECC data from one or more ECCs collected over a period of time from weeks, months or years. The prompts are accordingly adjusted iteratively until acceptable results are obtained in what may be considered a form of RLHF with respect to LLM prompt engineering.

As discussed previously above, the AI module may, in some embodiments, include one or more GPU servers that are designed specifically to accommodate training and utilization of AI deep learning models, and various machine learning models. The one or more GPU servers may, in some embodiments, be installed at an infrastructure operations center location or may be installed at an ECC location or a combination of both. In some embodiments, the GPU servers maybe cloud-based and form part of the IWS 150 cloud-infrastructure or may be ancillary cloud-based servers operatively coupled to the IWS 150 cloud infrastructure as illustrated in one example in FIG. 4.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A method comprising:
monitoring, by a cloud server and corresponding cloud application that are operatively coupled to an emergency communication center (ECC), data inputs to the ECC related to incoming emergency calls, the data inputs comprising voice data;
obtaining additional data by the cloud server and corresponding cloud application, from sources external to the ECC, the additional data related to the data inputs;
generating an incident record for each incoming emergency call by correlating the data inputs with the additional data and determining an incident type for each generated incident record;
determining units for dispatch to a location of each incident corresponding to an incident record; and
providing the determined incident records to an instance of the cloud application, and within a map view user interface, the instance executed using a browser on a computer located at the ECC.

2. The method of claim 1, further comprising:
performing an auto-dispatch operation of the units.

3. The method of claim 2, further comprising:
generating synthesized speech using generative artificial intelligence; and
utilizing the synthesized speech to perform the auto-dispatch operation of the units.

4. The method of claim 1, further comprising:
performing natural language processing on the data inputs and the additional data.

5. The method of claim 1, further comprising:
generating an incident record for each incoming emergency call via artificial intelligence.

6. The method of claim 1, further comprising:
generating an incident record for each incoming emergency call via a large language model (LLM).

7. The method of claim 1, wherein determining units for dispatch to a location of each incident corresponding to an incident record, comprises:
analyzing AVL (automatic vehicle location) data corresponding to the units, the data inputs comprising the AVL data.

8. The method of claim 1, further comprising:
monitoring, by a cloud server and corresponding cloud application, dispatch data inputs to the ECC related to responders present at an incident location, the dispatch data inputs comprising radio voice data.

9. The method of claim 8, further comprising:
updating the incident records based on analysis of the dispatch data inputs comprising radio voice data.

10. The method of claim 9, further comprising:
performing natural language processing on the radio voice data.

11. A cloud based intelligent workflow system comprising:
at least one cloud server, comprising a cloud application, operatively coupled to at least one ECC functional element, and operatively coupled non-volatile, non-transitory memory, the at least one cloud server operative to:
monitor data inputs to an emergency communication center (ECC) related to incoming emergency calls, the data inputs comprising voice data;
obtain additional data by the cloud server from sources external to the ECC, the additional data related to the data inputs;
generate an incident record for each incoming emergency call by correlating the data inputs with the additional data and determining an incident type for each generated incident record;
determine units for dispatch to a location of each incident corresponding to an incident record; and
provide the determined incident records to an instance of the cloud application, and within a map view user interface, the instance executed using a browser on a computer located at the ECC.

12. The system of claim 11, wherein the at least one cloud server is further operative to:
perform an auto-dispatch operation of the units.

13. The system of claim 12, wherein the at least one cloud server is further operative to:
generate synthesized speech using generative artificial intelligence; and
utilize the synthesized speech to perform the auto-dispatch operation of the units.

14. The system of claim 11, wherein the at least one cloud server is further operative to:
perform natural language processing on the data inputs and the additional data.

15. The system of claim 11, wherein the at least one cloud server is further operative to:
generate an incident record for each incoming emergency call via artificial intelligence.

16. The system of claim 11, wherein the at least one cloud server is further operative to:
generating an incident record for each incoming emergency call via a large language model (LLM).

17. The system of claim 11, wherein the at least one cloud server is further operative to:
analyze AVL (automatic vehicle location) data corresponding to the units, the data inputs comprising the AVL data.

18. The system of claim 11, wherein the at least one cloud server is further operative to:
monitor dispatch data inputs to the ECC related to responders present at an incident location, the dispatch data inputs comprising radio voice data.

19. The system of claim 11, wherein the at least one cloud server is further operative to:
update the incident records based on analysis of the dispatch data inputs comprising radio voice data.

20. The system of claim 11, wherein the at least one cloud server is further operative to:
performing natural language processing on radio voice data.

21. A method comprising:
monitoring, by an artificial intelligence module that is operatively coupled to an emergency communication center (ECC), data inputs to the ECC related to incoming emergency calls, the data inputs comprising voice data;
obtaining additional data by the artificial intelligence module, from sources external to the ECC, the additional data related to the data inputs;
generating an incident record for each incoming emergency call by correlating the data inputs with the additional data and determining an incident type for each generated incident record;
determining units for dispatch to a location of each incident corresponding to an incident record; and
providing the determined incident records to an instance of a cloud application that is operatively coupled to the artificial intelligence module, within a map view user interface, the instance executed using a browser on a computer located at the ECC.
